(19) United States
(12) Patent Application Publication
(10) Pub. No.: US 2024/0371566 A1
(43) Pub. Date: Nov. 7, 2024

(54) COIL COMPONENT

(71) Applicant: SAMSUNG ELECTRO-MECHANICS CO., LTD., Suwon-si (KR)

(72) Inventors: Woo Jin LEE, Suwon-si (KR); Hong Seok CHOI, Suwon-si (KR); Seung Hyun HONG, Suwon-si (KR); Hyo Chan OH, Suwon-si (KR)

(73) Assignee: SAMSUNG ELECTRO-MECHANICS CO., LTD., Suwon-si (KR)

(21) Appl. No.: 18/654,552

(22) Filed: May 3, 2024

(30) Foreign Application Priority Data
May 3, 2023 (KR) 10-2023-0057728

(51) Int. Cl. H01F 27/29; H01F 5/04

(52) U.S. Cl. CPC H01F 27/29; H01F 5/04

(57) ABSTRACT

A coil component includes: a body including a plurality of corners formed by side surfaces of the body adjacent to each other; a coil disposed in the body, and including one or more turns on a central axis, substantially parallel to the first direction; and an external electrode disposed on a surface of the body and connected to the coil, wherein an outermost turn of the coil includes a plurality of corner portions adjacent to the plurality of corners of the body, and at least one connection portion connecting the plurality of corner portions and adjacent to the side surface of the body, and when a maximum value of a line width in at least one of the plurality of corner portions is referred to as Dₘₐₓ, and a minimum value of a line width in the at least one connection portion is referred to as dₘᵢₙ, 1.05 dₘᵢₙ≤Dₘₐₓ≤1.20 dₘᵢₙ is satisfied.

### CROSS-REFERENCE TO RELATED APPLICATION(S)

The present application claims the benefit of priority to Korean Patent Application No. 10-2023-0057728, filed on May 3, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive device configured to remove noise by forming an electronic circuit with a resistor and a capacitor, and is used for a configuration of a resonance circuit and a filter circuit which amplify signals of specific frequency bands in combination with capacitors using electromagnetic properties.

For the implementation of high performance and multifunctionality of a mobile device, there is increasing demand for miniaturization and thinning of components to mount more components in a limited mounting space, and as a usage current increases significantly with the high performance of an application processor (AP) used in a smartphone, saturation current (Isat) characteristics required by a power inductor, which is a major component of a power supply terminal, are also increasing significantly. The miniaturization of the power inductor and the implementation of high saturation current characteristics denote that a current value per volume of the component increases, and for this purpose, various technologies for a material, a shape, and a structural design are being applied.

In order to lower a value of direct current resistance to improve the high current efficiency, a line width or thickness of the coil constituting the inductor needs to be increased, and in this case, a size of a core must inevitably be reduced or a cover thickness of a magnetic material must be lowered.

In the power inductor, the size of the core or the thickness of the magnetic cover is a major factor in determining saturation current characteristics, and DC current characteristics and saturation current characteristics are in a trade-off relationship. When the size of the core is reduced to a certain value or the cover thickness is lowered, the saturation current characteristic may be rapidly deteriorated.

### SUMMARY

An aspect of the present disclosure is to provide a coil component having an improved direct current resistance value without significant deterioration of saturation current characteristics.

According to an aspect of the present disclosure, a coil component including: a body including a first surface and a second surface, the second surface opposing the first surface in a first direction, a plurality of side surfaces connected to the first surface and the second surface, and a plurality of corners defined by side surfaces adjacent to each other among the plurality of side surfaces; a coil disposed in the body, and including one or more turns based on a central axis of the coil, substantially parallel to the first direction; and an external electrode disposed on a surface of the body and connected to the coil, in which an outermost turn of the coil includes a plurality of corner portions adjacent to the plurality of corners of the body, and at least one connection portion connecting the plurality of corner portions and adjacent to the respective side surfaces of the body, and when a maximum value of a line width in at least one of the plurality of corner portions is referred to as Dₘₐₓ, and a minimum value of a line width in the at least one connection portion is referred to as dₘᵢₙ, 1.05dₘᵢₙ≤Dₘₐₓ≤1.20dₘᵢₙ is satisfied.

According to another aspect of the present disclosure, provided is a coil component including: a body including a first surface and a second surface, the second surface opposing the first surface in a first direction, a plurality of side surfaces connected to the first surface and the second surface, and a plurality of corners defined by side surfaces adjacent to each other among the plurality of side surfaces; a coil disposed in the body, and including one or more turns based on a central axis of the coil, substantially parallel to the first direction; and an external electrode disposed on a surface of the body and connected to the coil, in which an outermost turn of the coil includes a plurality of corner portions adjacent to the plurality of corners of the body, and three or more connection portions connecting the plurality of corner portions, adjacent to the respective side surfaces of the body, and having a line width narrower than the plurality of corner portions.

According to an embodiment of the present invention, provided is a coil component having an improved direct current resistance value without significant deterioration of saturation current characteristics.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a transmission perspective view schematically illustrating a coil component according to an example embodiment of the present disclosure;

FIG. 2 is an exploded perspective view of the coil of FIG. 1 as viewed from above;

FIG. 3 is a plan view of the coil component of FIG. 1 as viewed from above;

FIG. 4 is an enlarged view of portion A of FIG. 3; and

FIG. 5 illustrates another embodiment of the present disclosure, and is a perspective view of a coil component as viewed from above.

### DETAILED DESCRIPTION

The term used herein is for the purpose of describing particular embodiments only and is not intended to be limiting of the present disclosure. The singular also includes the plural unless specifically stated otherwise in the phrase. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof. Furthermore, throughout the specification, the term “on” means being positioned above or below the object portion, but does not essentially mean being positioned on the upper side of the object portion based on a gravity direction.

The terms “coupled to,” “combined to,” and the like, may not only indicate that elements are directly and physically in contact with each other, but may also include the configuration in which the other element is interposed between the elements such that the elements are also in contact with the other component.

Hereinafter, embodiments of the present disclosure will be described with reference to specific example embodiments and the attached drawings. The embodiments of the present disclosure may, however, be exemplified in many different forms and should not be construed as being limited to the specific embodiments set forth herein. The example embodiments disclosed herein are provided for those skilled in the art to better explain the present disclosure. In the drawings, the shapes and dimensions of elements may be exaggerated for clarity, and the same reference numerals will be used throughout to designate the same or like elements.

Various types of electronic components are used in electronic devices, and various types of coil components may be appropriately used between these electronic components for the purpose of removing noise. In other words, a coil component in an electronic device may be used as a power inductor, a high frequency inductor, a general bead, a high frequency bead (GHz Bead), a common mode filter, and the like.

### Coil Component

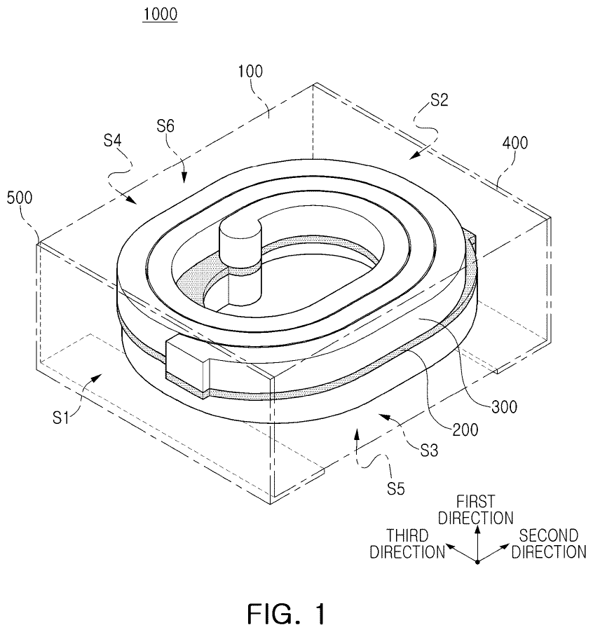

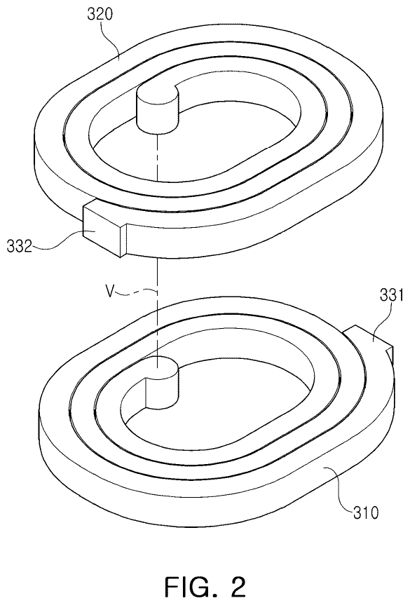

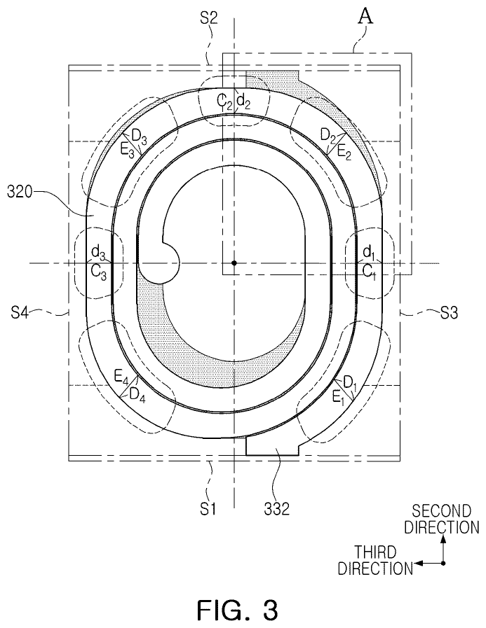

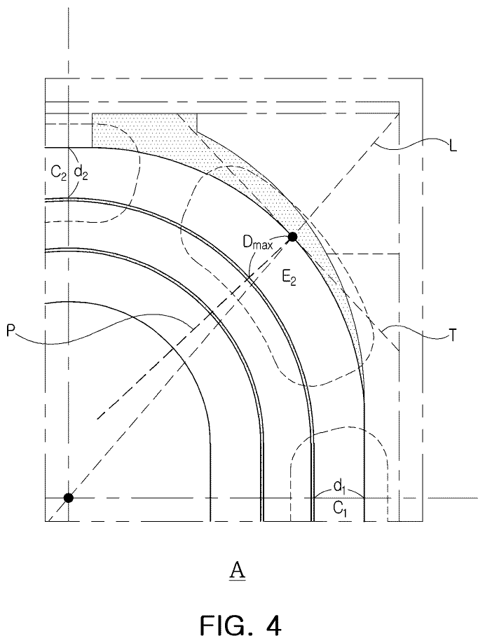

FIG. 1 is a transmission perspective view schematically illustrating a coil component according to an example embodiment of the present disclosure. FIG. 2 is an exploded perspective view of the coil of FIG. 1 as viewed from above. FIG. 3 is a plan view of the coil component of FIG. 1 as viewed from above. FIG. 4 is an enlarged view of portion A of FIG. 3.

Referring to FIG. 1, a coil component 1000 according to an example embodiment includes a body 100, a support member 200, a coil 300, and external electrodes 400 and 500.

The body 100 may have the support member 200, the coil 300, and the like disposed therein, and form an overall appearance of the coil component 1000. The body 100 includes one surface S5 and the other surface S6 opposing each other in a first direction (X-direction), and a plurality of side surfaces (a first surface, a second surface, a third surface, and a fourth surface) connecting one surface and the other surface. Specifically, the first surface S1 and the second surface S2 oppose each other in a second direction (Y-direction) and connect one surface S5 and the other surface S6, and the third surface S3 and the fourth surface S4 oppose each other in a third direction (Z-direction) and connect one surface S5 and the other surface S6. Here, the first direction (X-direction), the second direction (Y-direction), and the third direction (Z-direction) may be perpendicular to each other. Furthermore, the first direction (X-direction) may correspond to a thickness direction of the body 100 and the support member 200. In the following description, the first direction (X-direction), the second direction (Y-direction), and the third direction (Z-direction) each represent both directions, and for example, the first direction (X-direction) includes both upward and downward directions based on the drawing.

Referring to FIG. 3, the body 100 includes a plurality of corners formed by side surfaces adjacent to each other among a plurality of side surfaces (the first surface, the second surface, the third surface and the fourth surface). Specifically, a corner is formed by the first surface S1 and the fourth surface S4, a corner is formed by the fourth surface S2 and the second surface S2, and a corner is formed by the second surface S2 and the third surface S3, and a corner is formed by the third surface S3 and the first surface S1. The corners may be formed when adjacent surfaces meet vertically, but the present disclosure is not limited thereto. Depending on the number of a plurality of side surfaces, the corners may not be vertical, or the corners may be rounded depending on the process. The body 100 may include a resin and a magnetic material. Specifically, the body 100 may be formed by stacking one or more magnetic composite sheets in which a magnetic material is dispersed in a resin. The magnetic material may be ferrite or magnetic metal powder particles. The ferrite may be, for example, at least one of spinel-type ferrite such as a Mg—Zn—based material, a Mn—Zn—based material, a Mn—Mg—based material, a Cu—Zn—based material, a Mg—Mn—Sr-based material and a Ni—Zn-based material, hexagonal ferrite such as a Ba—Zn—based material, a Ba—Mg—based material, a Ba—Ni—based material, a Ba—Co—based material and a Ba—Ni—Co-based material, and Li—based ferrite. The magnetic metal powder particles may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si alloy powder particles, Fe—Si—Al alloy powder particles, Fe—Ni—based alloy powder particles, Fe—Ni—Mo-based alloy powder particles, Fe—Ni—Mo—Cu based alloy powder particles, Fe—Co based alloy powder particles, Fe—Ni—Co based alloy powder particles, Fe—Cr based alloy powder particles, Fe—Cr—Si alloy powder particles, Fe—Si—Cu—Nb alloy powder particles, Fe—Ni—Cr-based alloy powder particles, and Fe—Cr—Al-based alloy powder particles. The magnetic metal powder particles may be amorphous or crystalline. For example, the magnetic metal powder particles may be Fe—Si—B—Cr-based amorphous alloy powder particles, but the present disclosure is not limited thereto. Each of the ferrite and the magnetic metal powder particles may have an average diameter of about 0.1 μm to about 30 μm, but the present disclosure is not limited thereto. The body 100 may include two or more kinds of magnetic materials dispersed in the resin. Here, different types of magnetic materials denote that the magnetic materials dispersed in the resin are distinguished from each other by any one of an average diameter, a composition, crystallinity, and a shape. The resin may include epoxy, polyimide, a liquid crystal polymer, or the like, alone or in combination thereof, but the present disclosure is not limited thereto.

In relation to an example of a manufacturing method, the body 100 may be formed using a stacking method. Specifically, a plurality of unit stacked bodies for manufacturing the body 100 may be provided and stacked on upper and lower portions of the coil 300. Here, the unit stacked body may be manufactured in a sheet type by manufacturing a slurry by mixing magnetic particles such as metal with organic materials such as a thermosetting resin, a binder and a solvent, and applying the slurry at a thickness of several tens of μm on a carrier film in a doctor blade method and then drying the same. Accordingly, the unit stacked body may be manufactured in a form in which magnetic particles are dispersed in a thermosetting resin such as an epoxy resin or polyimide.

A size of the body 100 of the coil component according to an example embodiment may be similar to a length in the second direction (Y-direction) and the third direction (Z-direction). For example, the coil component 1000 according to an example embodiment, in which the external electrodes 400 and 500 to be described below are formed, may have a second direction length of 1.4 mm and a third direction length of 1.2 mm, or a second direction length of 1.2 mm and a third direction length of 1.0 mm. However, the present disclosure is not limited thereto, and when improvement in characteristics of component to be described below is required, a structure of the coil component according to an example embodiment may be applied.

The coil component according to the present embodiment may include a support member 200. The support member 200 supports a coil 300 to be described below, and may be formed of, for example, a polypropylene glycol (PPG) substrate, a ferrite substrate, or a metal-based soft magnetic substrate. However, according to an example embodiment, the support member 200 may not be provided, and for example, when a coil of a winding structure is used, the support member 200 may not be required separately. As illustrated, a part of the support member 200 penetrates through to form a through-hole, and a material forming the body 100 is filled in the through-hole to form the core 110.

The coil component according to an example embodiment includes the coil 300. The coil 300 may be disposed in the body 100, and may be disposed on at least one surface of the support member 200. The coil 300 may include a first coil 310 disposed on one surface (in the example embodiment, a lower surface based on the drawing) of the support member 200 and a second coil 320 disposed on the other surface (in the example embodiment, an upper surface based on the drawing) of the support member 200. Hereinafter, the structure of the coil 300 will be described with reference to FIGS. 1 to 4.

FIG. 2 is an exploded perspective view of the coil of FIG. 1 as viewed from above.

The coil 300 may include a first coil 310 and a first lead-out portion 331 disposed on one surface of the support member 200. The coil 300 may include a second coil 320 and a second lead-out portion 332 disposed on the other surface of the support member 200.

The first coil 310 and the second coil 320 form one or more turns around the core 110 and may have a planar spiral shape. Specifically, one or more turns may be formed on a central axis, substantially parallel to the first direction (X-direction). However, the present disclosure is not limited thereto.

Referring to FIG. 2, the first coil 310 is in contact with and connected to the first lead-out portion 331 on a lower surface of the support member 200. The second coil 320 is in contact with and connected to the second lead-out portion 332 on an upper surface of the support member 200.

The first lead-out portion 331 extends to the second surface S2 and is connected to a first external electrode 400 to be described below. The second lead-out portion 332 extends to the first surface S1 and is connected to a second external electrode 500 to be described below.

A via V penetrates through the support member 200 and is in contact with the first coil 310 and the second coil 320, respectively. In this manner, the coil 300 may function as one coil as a whole.

The coils 310 and 320 may form one or more turns on a central axis, substantially parallel to the first direction (X-direction). In this case, an outermost turn based on the central axis may be referred to as an outermost turn, and a turn excluding the outermost turn may be referred to as an inner turn.

The outermost turns of the coils 310 and 320 may have an inner surface facing an adjacent turn and an outer surface opposing the inner surface.

The outermost turn of the coils 310 and 320 may include a plurality of corner portions E adjacent to a plurality of corners of the body 100 and at least one connection portion C connected to the plurality of corner portions E and adjacent to a side surface of the body 100. Hereinafter, the corner portion E and the connection portion C will be described in detail.

A plurality of corner portions E are formed on the outermost turn of the coil. The corner portions E are adjacent to a plurality of corners of the body 100. Each of the plurality of corner portions E may form a turn of ¼ or less based on the central axis. A curvature of at least one of an inner surface and an outer surface of the plurality of corner portions E may be greater than 0. The outermost turn of the coils 310 and 320 may include four corner portions E. Referring to FIG. 3, since the number of the plurality of corners of the body 100 are four, four corner portions E may be formed to correspond to each of the corners. Specifically, referring to FIG. 3, each of four corner portions E may be adjacent to a corner formed by the first surface S1 and the fourth surface S4, a corner formed by the fourth surface S4 and the second surface S2, a corner formed by the second surface S2 and the third surface S3, and a corner formed by the third surface S3 and the first surface S1. For convenience, the corner portions may be referred to as E₁, E₂, E₃, and E₄ in an order adjacent to lead-out portions of the coil lead-out portions 331 and 332 along the turn, and maximum values of a line width at each of the corner portions E₁, E₂, E₃, and E₄ may be referred to as D₁, D₂, D₃, and D₄, respectively. The number of the plurality of corner portions E is not necessarily limited to four, and may be four or more depending on the number of corners formed by a plurality of side surfaces of the body 100. In addition, although it is illustrated that the connection portion C and the plurality of corner portions E are spaced apart from each other, the plurality of corner portions E may be directly connected to the connection portion C.

A line width of the corner portion E may not be constant. The line width in at least one of the corner portions E may have Dₘₐₓ as a maximum value. Specifically, the corner portion E may have a maximum line width at a portion closest to the corner of the body 100. This will be described in detail below with reference to FIG. 4. When there are four corner portions E, since maximum values of the line widths at the plurality of corner portions may be referred to as D₁, D₂, D₃, and D₄, respectively, Dₘₐₓ may refer to any one of D₁, D₂, D₃, and D₄, respectively.

The corner portion E may increase and decrease in line width from one end to the other end. When a maximum value of a line width in at least one of the plurality of corner portions E is Dₘₐₓ, the line width may increase from one end to the other end, the corner portion E has Dₘₐₓ as the maximum value of the line width, and then, the line width may decrease again. Line widths of ends of the plurality of corner portions E may be line widths d (d₁, d₂, and d₃) of the connection portion C connected to ends of the corresponding corner portions E, but the present disclosure is not necessarily limited thereto. The line widths of one end and the other end of the plurality of corner portions E need not be the same, and each of line widths may be less than Dₘₐₓ.

When a cross-section viewed from the coil component in the first direction (X-direction) is divided into virtual quadrants, the corner portion E may be disposed in any one quadrant. Specifically, referring to FIG. 3, it can be confirmed that each of the four corner portions E is disposed in one quadrant. Here, ‘disposed within one quadrant’ includes a case of being disposed on a virtual quadrant boundary.

At least one connection portion C is formed on the outermost turn of the coil. The connection portion C is connected to the plurality of corner portions E and is adjacent to the side surface of the body 100. The connection portion C refers to a portion of the coil disposed between the plurality of corner portions E and adjacent to the side surface of the body 100.

The connection portion C may be continuously connected to the plurality of corner portions E, but is not limited thereto. The connection portions C may be disposed between the plurality of corner portions E, and may be adjacent to different side surfaces of the body 100, respectively. The plurality of corner portions E and the connection portion C may be alternately formed in the outermost turn of the coil. For example, when there are four corner portions E in the outermost turn, three connection portions C may be disposed between each of the corner portions E₁, E₂, E₃, and E₄. Specifically, referring to FIG. 3, it may be confirmed that three connection portions C are formed to be adjacent to the third surface S3, the second surface S2, and the fourth surface S4 in the outermost turn, respectively. For convenience, the connection portions may be referred to as C₁, C₂, and C₃ in the order adjacent to the lead-out portions of the coil lead-out portions 331 and 332 along the turn. However, the present disclosure is not limited thereto, and at least one connection portion C may be formed in the outermost turn, and three or more connection portions C may be formed according to the number of corner portions E.

The line width of the connection portion C may be constant, and a curvature of the inner surface and the outer surface of the connection portion C may be substantially 0. The connection portion C may be substantially parallel to the side surface of the adjacent body. Here, ‘the line width being constant’ includes a case in which the line width is substantially the same, and denote that the line width is the same, including process errors, position deviations, and errors during measurement occurring in a manufacturing process. Specifically, when there are three connection portions C, line widths of each of the connection portions C₁, C₂, and C₃ may be constant at d₁, d₂, and d₃, and each of the connection portions C₁, C₂, and C₃ may be substantially parallel to side surfaces (the third surface, the second surface, and the fourth surface in case of FIG. 3) of an adjacent body. Here, d₁, d₂, and d₃ may be the same. However, the present invention is not limited thereto, and values of the d₁, d₂, and d₃ may be different.

When the cross-section viewed from the coil component in the first direction (X-direction) is divided into virtual quadrants, the connection portion C may be disposed to span two consecutive quadrants. Specifically, referring to FIG. 3, each of the three connection portions C is disposed to span two quadrants, and penetrates through a virtual quadrant boundary. Referring to FIG. 3, the connection portion C is illustrated to have a length in the second direction (Y-direction) or the third direction (Z-direction) in a region having a constant line width among the outermost turns of the coils 310 and 320, but the present disclosure is not limited thereto, and the length may be infinitely reduced, so that the connection portion may refer to a point of a coil where the plurality of corner portions E are connected to each other.

Hereinafter, the effect of the present disclosure according to the design of the line width of the corner portion E and the connection portion C will be described in detail.

In order to lower a value of a direct current resistance Rdc to improve high current efficiency, it may be necessary to increase the line width or the thickness of the coil constituting the inductor, and in this case, a size of the core must inevitably be reduced or a cover thickness of a magnetic material must be lowered.

In a power inductor, the size of the core or the thickness of the magnetic cover is a major factor in determining saturation current characteristics, and DC current characteristics and the saturation current characteristics are in a trade-off relationship, but when the size of the core is reduced to a certain value or the cover thickness is reduced, the saturation current characteristics may be rapidly deteriorated.

When a region in which the magnetic material is filled inside the coil is referred to as an inner core, and a region in which the magnetic material is filled on the outside of the coil is referred to as an outer core, in a thin-film power inductor, a cross-sectional area of the inner core may decrease as the line width of the coil increases, and accordingly, the distribution of magnetic flux density distributed in the inner core may increase. A higher magnetic flux density can make the inductance higher, but when the magnetic flux density becomes too high in a certain area, the magnetic material may be saturated even with a low current value, which may more quickly express non-linear characteristics of the magnetic material in which the permeability of the magnetic material decreases and inductance decreases.

Accordingly, in the inductor, the distribution of the magnetic flux density distributed inside the component need to be made more uniform within a three-dimensional volume.

For a coil component according to the conventional structure, a line width of a coil is kept constant, and the magnetic flux density is relatively low at corners of the coil component. Accordingly, inductance is implemented significantly low at the corresponding corner, and even if a magnetic filling rate is reduced by expanding the line width of a coil portion adjacent to the corresponding corner, inductance deterioration may be minimized.

Accordingly, in the present disclosure, a coil structure of the coil component for lowering a direct current resistance without significant deterioration of saturation current characteristics is proposed as follows.

When a maximum value of a line width in at least one of the plurality of corner portions E is referred to as Dₘₐₓ, and a minimum value of the line width in at least one connection C is referred to as dₘᵢₙ, 1.05dₘᵢₙ<Dₘₐₓ≤1.20dₘᵢₙ may be satisfied.

That is, the maximum value Dₘₐₓ of the line width in at least one of the plurality of corner portions E may be greater than the minimum value dₘᵢₙ of the line width in at least one connection portion C by 5% to 20%.

For example, when the number of the plurality of corner portions E are four, since the maximum values of the line widths in the plurality of corner portions E₁, E₂, E₃, and E₄ may be referred to as D₁, D₂, D₃, and D₄, respectively, Dₘₐₓ may refer to any one of D₁, D₂, D₃, and D₄.

For example, when there are three connection portions C, the minimum value dₘᵢₙ of the line width in the connection portions C₁, C₂, and C₃ may denote a minimum value of d₁, d₂, and d₃.

The line width of the connection portion C may be narrower than that of the plurality of corner portions E. That is, the line width of the connection portion C may be narrower than that of an arbitrary corner portion E. Here, ‘narrow line width’ may denote a case in which a value of the line width of the connection portion C is smaller than a maximum value D of the line width at an arbitrary corner portion E. Specifically, when there are four corner portions E and three connection portions C, line widths of each of the connection portions C₁, C₂, and C₃ may be constant at d₁, d₂, and d₃, the di, d₂, and d₃ may be smaller than maximum values D₁, D₂, D₃, and D₄ of the line width at any of the corner portions E₁, E₂, E₃, and E₄. That is, the line width may change along the outermost turn of the coil, and the line width in the connection portions C₁, C₂, and C₃ may have a minimum value or a smallest value.

For example, based on an optical microscope image or Scanning Electron Microscope (SEM) image of a second direction (Y-direction)-third direction (Z-direction) cross-section taken from the center of the coil 300 in the first direction (X-direction) of the coil component 1000, the line width of the coil 300 may be measured by connecting the boundaries of each of the inner and outer surfaces of the connection portion C shown in the image opposing each other.

Referring to FIG. 4, a method of measuring a maximum value of the line width of the connection portion C and the line width of the corner portion E will be described.

The connection portion C may be adjacent to side surfaces S1, S2, S3, and S4 of the body 100, and may be disposed at a center of the second direction (Y-direction) or the third direction (Z-direction) of the body 100. Accordingly, based on the cross-sectional image, a line width d of the connection portion C may be obtained by measuring the line width in the coil disposed at the center of the body 100 in the second direction (Y-direction) or the third direction (Z-direction).

The corner portion E may be adjacent to a plurality of corners of the body 100, and the line width may be maximized at a portion closest to the corner of the body 100. In an example, the portion closest to the corner of the body 100 may be obtained as follows. Referring to FIG. 4, a virtual line L connecting the corner of the body 100 from the center of the body 100 is displayed. The line width may be maximized at a point in which the virtual line L meets the outermost turn of the coil. Specifically, the maximum value of the line width at the corner portion E may be obtained by drawing a tangent T at a point in which the line width is maximized, based on the cross-sectional image and then measuring a line width (maximum value Dₘₐₓ) of the coil along a perpendicular line (P) direction perpendicular to the tangent T.

However, the present disclosure is not limited thereto, and depending on the design, the point at which the line width is maximized at the corner portion E may be changed.

Table 1 below is a table showing characteristics (inductance and saturation current) of the coil component depending on the minimum value dₘᵢₙ of the line width of the connection portion C as compared to the maximum value Dₘₐₓ of the line width of the corner portion E. For characteristics of the component, Ls 0.3 uH or more and Isat 6.0A are required, and whether required characteristics are satisfied in a comparative example and each experimental example is indicated.

In samples 1 to 7 of Table 1, the size of coil components is the same with a second directional length of 1.505 mm, a third directional length of 1.305 mm, and a first directional length of 0.590 mm.

In Table 1 below, Sample 1 represents a coil component of a conventional structure as a comparative example, and the line width of the coil is constant.

Samples 2 to 7 in Table 1 below are experimental examples, and a maximum value Dₘₐₓ of the line width of the corner portion E has a value greater than a minimum value dₘᵢₙ of the line width of the connection portion C.

TABLE 1

| | | | | | | Whether to |
|---|---|---|---|---|---|---|
| | | | Increase | | | satisfy |
| | dₘᵢₙ | Dₘₐₓ | Rate | Ls | Isat | required |
| Sample | [um] | [um] | — | [uH] | [A] | characteristics |
| 1 | 98 | 98 | 0% | 0.297 | Initial 5.9 | X |
| 2 | 98 | 99.96 | 2% | 0.301 | Initial 5.9 | X |
| 3 | 98 | 102.9 | 5% | 0.302 | Initial 6.0 | ◯ |
| 4 | 98 | 107.8 | 10% | 0.303 | Initial 6.0 | ◯ |
| 5 | 98 | 114.66 | 17% | 0.302 | Initial 6.1 | ◯ |
| 6 | 98 | 117.6 | 20% | 0.301 | Initial 6.05 | ◯ |
| 7 | 98 | 122.5 | 25% | 0.298 | Initial 6.0 | X |

Referring to Table 1 above, when the maximum value Dₘₐₓ of the line width of the corner portion E is greater than the minimum value dₘᵢₙ of the line width of the connection portion C, characteristics of the inductor are improved. Specifically, when the maximum value Dₘₐₓ of the line width of the corner portion E is greater than the minimum value dₘᵢₙ of the line width of the connection portion C by 5% to 20%, it may be confirmed that a value of a direct current resistance Rdc is improved without significant deterioration of saturated current characteristics.

That is, as described above, when the line width of the coil increases at the corner portion E of the outermost turn of the coil, a value of direct current resistance Rdc may be improved without significant deterioration of the saturation current characteristic. Meanwhile, as in sample 7, when the maximum value Dₘₐₓ of the line width of the corner portion E is significantly large than the minimum value dₘᵢₙ of the line width of the connection portion C, the magnetic flux density at the corners of the body may become significantly high. In this case, the magnetic material is saturated even with a small current value, and thus the permeability of the material decreases, which may more quickly express the non-linear characteristics of the magnetic material in which inductance is reduced.

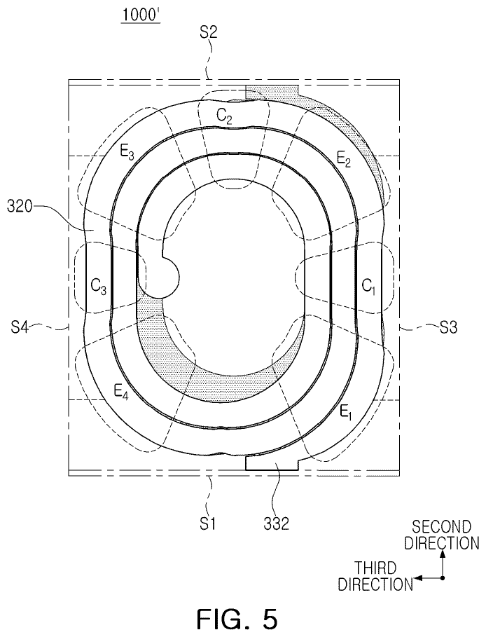

FIG. 5 illustrates another embodiment of the present disclosure, and is a perspective view of a coil component 1000′ as viewed from above.

For outermost turns of coils 310 and 320 of the coil component 1000′, it has been described that a corner portion E and a connection portion C may be formed, but for an inner turn of the coil 300, the corner portion E and the connection portion C described above may be formed. Specifically, the inner turns of the coils 310 and 320 may include a plurality of corner portions E adjacent to a plurality of corners of the body 100 and at least one connection portion C connected to the plurality of corner portions and adjacent to a side surface of the body.

The description of the corner portion E and the connection portion C formed on the outermost turn of the coil 300 may be inferred and applied to the description of the corner portion E and the connection portion C formed in the inner turns of the coils 310 and 320. Details are overlapped and thus will be omitted.

In one embodiment, when viewed from the first direction, each of the plurality of connection portions C formed in the outermost turn of the coil 300 may include an indented portion from an outer surface thereof.

At least one of the components constituting the coil 300 may include one or more conductive layers. For example, when the coil 300 is formed by applying a plating process to a surface of the support member 200, at least one of the components constituting the coil 300 may include a first conductive layer formed by electroless plating or the like, and a second conductive layer disposed on the first conductive layer. The first conductive layer may be a seed layer for forming the second conductive layer on the support member 200 by plating, and the second conductive layer may be an electroplating layer. Here, the electroplating layer may have a single layer structure or a multilayer structure. The electroplating layer having a multilayer structure may be formed in a conformal film structure in which one electroplating layer is covered with another electroplating layer, or may be formed in a shape in which the other electroplating layer is stacked on only one surface of any one electroplating layer. The coil 300 may be formed of conductive materials such as copper (Cu), aluminum (Al), silver (Ag), tin (Sn), gold (Au), nickel (Ni), lead (Pb), titanium (Ti), or alloys thereof, but the present disclosure is not limited thereto.

Although not illustrated in the drawings, an insulating film may be formed on a surface of the coil 300. The insulating film may integrally cover the coil 300 and the support member 200. Specifically, the insulating film may be disposed between the coil 300 and the body 100, and between the support member 200 and the body 100. The insulating film may be formed along a surface of the support member 200 on which the coil 300 is formed, but the present disclosure is not limited thereto. The insulating film is for electrically separating the coil 300 and the body 100, and may include a known insulating material such as parylene and the like, but the present disclosure is not limited thereto. In another example, the insulating film may include an insulating material such as an epoxy resin other than parylene. The insulating film may be formed by a vapor deposition method, but the present disclosure is not limited thereto. In another example, the insulating film may be formed by stacking and curing insulating films for forming an insulating film on both surfaces of the support member 200 on which the coil 300 is formed, and may be formed by applying and curing an insulating paste for forming an insulating film to both surfaces of the support member 200 on which the coil 300 is formed. Meanwhile, for the above-described reasons, the insulating film is a configuration that may be omitted in this example embodiment. That is, when the body 100 has sufficient electrical resistance in a designed operating current and voltage of the coil component 1000, the insulating layer may be omitted in this example embodiment.

The external electrodes 400 and 500 are disposed on the surface of the body 100. The external electrode may include first and second external electrodes 400 and 500 connected to the first and second coils 310 and 320, respectively. Specifically, the first and second external electrodes 400 and 500 are disposed on the second surface S2 and the first surface S1 of the body 100, respectively, and are connected to a first lead-out portion 331 and the second lead-out portion 332, respectively. When the coil component 1000 is mounted on an electronic device or the like, the first and second external electrodes 400 and 500 may serve to electrically connect the coil 300 in the coil component 1000 to the electronic device.

The first and second external electrodes 400 and 500 may be formed of conductive materials such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto. The first and second external electrodes 400 and 500 may be formed in a structure of a plurality of layers. For example, a first layer in which the first and second external electrodes 400 and 500 are connected to the coil 300 may be a conductive resin layer including conductive powder particles including at least one of copper (Cu) and silver (Ag) and an insulating resin, or a copper (Cu) plating layer. In addition, a second layer may have a double layer structure of a nickel (Ni) plating layer and a tin (Sn) plating layer. The first layer may be formed by electroplating, may be formed by vapor deposition such as sputtering, or may be formed by applying and curing a conductive paste including conductive powder particles such as copper (Cu) and/or silver (Ag), and the second layer may be formed by the electroplating.

Although an example embodiment of the present disclosure has been described, it will be apparent to those skilled in the art that modifications and variations could be made without departing from the concept of the present disclosure by adding, modifying, or deleting components, but these additions, modifications, or deletions are also construed as being in the technical scope of the present disclosure.

What is claimed is:

1. A coil component, comprising:
a body including a first surface and a second surface, the second surface opposing the first surface in a first direction, a plurality of side surfaces connected to the first surface and the second surface, and a plurality of corners defined by side surfaces adjacent to each other among the plurality of side surfaces;
a coil disposed in the body, and including one or more turns based on a central axis of the coil, substantially parallel to the first direction; and
an external electrode disposed on a surface of the body and connected to the coil,
wherein an outermost turn of the coil includes a plurality of corner portions adjacent to the plurality of corners of the body, and at least one connection portion connecting the plurality of corner portions and adjacent to the respective side surfaces of the body, and
when a maximum value of a line width in at least one of the plurality of corner portions is referred to as Dₘₐₓ, and a minimum value of a line width in the at least one connection portion is referred to as dₘᵢₙ,
1.05dₘᵢₙ≤ Dₘₐₓ≤1.20dₘᵢₙ is satisfied.

2. The coil component according to claim 1, wherein each of the plurality of corner portions forms a turn of ¼ or less based on the central axis.

3. The coil component according to claim 1, wherein the number of the plurality of corner portions at the outermost turn of the coil are four.

4. The coil component according to claim 1, wherein the line width of the at least one connection portion is constant.

5. The coil component according to claim 4, wherein the connection portion is substantially parallel to one of the side surfaces of the body.

6. The coil component according to claim 1, wherein the plurality of corner portions and the at least one connection portion are continuously connected to each other.

7. The coil component according to claim 1, wherein when a cross-section of the coil component viewed in the first direction is divided into virtual quadrants, each of the plurality of corner portions is disposed in one of the virtual quadrants.

8. The coil component according to claim 1, wherein when a cross-section of the coil component viewed in the first direction is divided into virtual quadrants, the at least one connection portion is disposed to span two consecutive quadrants.

9. The coil component according to claim 1, wherein an inner turn of the coil comprises a plurality of corner portions adjacent to the plurality of corners of the body and at least one connection portion connecting the plurality of corner portions and adjacent to one of the side surfaces of the body, and
when a maximum value of a line width in at least one of the plurality of corner portions of the inner turn of the coil is referred to as D′ₘₐₓ, and a minimum value of a line width in the at least one connection portion of the inner turn of the coil is referred to as d′ₘᵢₙ,
1.05 d′ₘᵢₙ≤ D′ₘₐₓ≤1.20d′ₘᵢₙ is satisfied.

10. The coil component according to claim 1, further comprising:
a support member disposed in the body and configured to support the coil,
wherein the coil is disposed on at least one surface of the support member.

11. A coil component, comprising:
a body including a first surface and a second surface, the other surface opposing the first surface in a first direction, a plurality of side surfaces connected to the first surface and the second surface, and a plurality of corners defined by side surfaces adjacent to each other among the plurality of side surfaces;
a coil disposed in the body, and including one or more turns based on a central axis of the coil, substantially parallel to the first direction; and
an external electrode disposed on a surface of the body and connected to the coil,
wherein an outermost turn of the coil includes a plurality of corner portions adjacent to the plurality of corners of the body, respectively, and three or more connection portions connecting the plurality of corner portions, adjacent to the respective side surfaces of the body, and each corner portion having a line width narrower than a line width of each of the plurality of corner portions.

12. The coil component according to claim 11, wherein each of the plurality of corner portions has a line width that increases and then decreases from one end to the other end.

13. The coil component according to claim 11, wherein the plurality of corner portions and the connection portions are disposed alternately at the outermost turn of the coil.

14. The coil component according to claim 11, wherein an inner turn of the coil comprises a plurality of corner portions adjacent to the plurality of corners of the body, respectively, and three or more connection portions connecting the plurality of corner portions, adjacent to the respective side surfaces of the body, and each corner portion having a line width narrower than the plurality of corner portions.

15. The coil component according to claim 11, wherein when viewed from the first direction, each of the plurality of connection portions disposed at the outermost turn of the coil include an indented portion from an outer surface thereof.
